(19) United States
(12) Patent Application Publication
(10) Pub. No.: US 2026/0237400 A1
(43) Pub. Date: Aug. 13, 2026

(54) DUBBING QUALITY ASSESSMENTS AND PROACTIVE RESPONSES FOR REAL-TIME VIDEO DUBBING ON A CLIENT DEVICE

(71) Applicant: Microsoft Technology Licensing, LLC, Redmond, WA (US)

(72) Inventors: Utkarsh CHAUHAN, Noida (IN); Rupeshkumar Rasiklal MEHTA, Telangana (IN); Suhrid Kiran PALSULE, Telangana (IN); Arijit MUKHERJEE, Telangana (IN); Shubham BANSAL, Telangana (IN); Vikas JOSHI, Karnataka (IN)

(21) Appl. No.: 19/049,805

(22) Filed: Feb. 10, 2025

(51) Int. Cl. G10L 25/60; G06F 40/58; G10L 15/06; G10L 25/57; G11B 27/031

(52) U.S. Cl. CPC G10L 25/60; G06F 40/58; G10L 15/063; G10L 25/57; G11B 27/031

(57) ABSTRACT

This disclosure describes a framework for analyzing dubbed audio segments (audio translations converted into translated speech) of videos where the dubbed audio segments are generated in real time, including being generated locally on a client device. For instance, this disclosure describes a video dubbing system that utilizes various lightweight machine learning models to determine the dubbing quality (e.g., a dubbing quality score) of a real-time generated dubbed segment and identify the cause of low-quality dubbing segments (e.g., the root cause of a low-quality score). In addition, the video dubbing system provides proactive indications to a video player to signal poor-quality dubbing segments before or while they play. Furthermore, the video dubbing system can provide reasoning behind why a particular segment of a streaming video has low-quality dubbing before or when a dubbed audio segment begins playback.

### BACKGROUND

As videos are shared with a global audience, it is important to consider the language barriers that exist. Many individuals who speak different languages may want to watch these videos, but they need translations to understand the narrative or other audio content. Unfortunately, not all videos have audio tracks available in different languages. Some video playback systems attempt to provide automatic translations for videos, but these systems face several challenges. For example, many video playback systems struggle with dubbing quality in various segments of a video. Additionally, many video playback systems suffer from further technical problems, as outlined below.

### BRIEF DESCRIPTION OF THE DRAWINGS

The following detailed description provides specific implementations accompanied by drawings. Additionally, each of the figures listed below includes illustrated examples corresponding to one or more implementations discussed in this disclosure.

FIG. 1 illustrates an overview of the video dubbing system that utilizes various machine learning models and dubbing metrics to determine the dubbing quality of segments and proactively respond to low-quality dubbing segments.

FIG. 2 illustrates a computing environment in which the video dubbing system is implemented.

FIG. 3 illustrates a high-level block diagram of the video dubbing system determining dubbing quality scores for dubbed audio segments and proactively notifying users.

FIGS. 4A-4B illustrate the implementation and training of a dubbing quality estimation model to generate dubbing quality scores.

FIGS. 5A-5B illustrate the implementation and training of a dubbing quality reasoning model to determine root causes for low-quality dubbing segments.

FIG. 6 illustrates an example graphical user interface for displaying a low-quality dubbing indication within a video player.

FIG. 7 illustrates an example series of acts in a computer-implemented method for generating real-time audio dubbing metrics in one or more videos.

FIG. 8 illustrates example components included within a computer system used to implement the video dubbing system.

### DETAILED DESCRIPTION

This disclosure describes a framework for analyzing dubbed audio segments (audio translations converted into translated speech) of videos where the dubbed audio segments are generated in real time, including being generated locally on a client device. For instance, this disclosure describes a video dubbing system that utilizes various lightweight machine learning models to determine the dubbing quality (e.g., a dubbing quality score) of a real-time generated dubbed segment and identify the cause of low-quality dubbing segments (e.g., the root cause of a low-quality score). In addition, the video dubbing system provides proactive indications to a video player to signal poor-quality dubbing segments before or while they play. Furthermore, the video dubbing system can provide reasoning behind why a particular segment of a streaming video has low-quality dubbing before or when a dubbed audio segment begins playback.

Implementations of the present disclosure provide benefits and solve problems in the art with systems, computer-readable media, and computer-implemented methods by using a video dubbing system to generate dubbing quality scores based on dubbing metrics and perform preventative actions when an upcoming dubbed audio segment is determined to be of low quality. Indeed, as described below, the video dubbing system utilizes multiple lightweight machine learning models on a client device to provide low-quality dubbing indications for videos dubbed locally in real time (or near-real time, meaning real time with a slight initial buffer) on the client device.

The following provides an example of the video dubbing system generating real-time audio dubbing metrics in one or more videos on a client device. In various implementations, the video dubbing system generates a dubbed audio segment in a second language from an audio segment of a video in a first language utilizing a speech dubbing model on a client device. The video dubbing system can also determine dubbing metric values in real time corresponding to the generation of the dubbed audio segment and determine a dubbing quality score for the dubbed audio segment based on the dubbing metric values using a dubbing quality estimation model. Additionally, the video dubbing system can determine when a dubbing quality score for the dubbed audio segment is below a dubbing quality threshold and, in response, provide a low-quality dubbing indication to a video player indicating that the video segment associated with the audio segment is of poor dubbing quality to be displayed before or during the video segment (e.g., the dubbed audio segment) being played.

As mentioned, current video playback systems face several technical challenges, especially video playback systems that provide real-time dubbing services on a client device. For example, when poor-or low-quality dubbed audio is generated, many of these existing systems cannot detect when the dubbing quality is poor or subpar, as no high-quality ground-truth standard is available for comparison. As a result, these existing systems are unable to react or improve based on generated low-quality dubbed audio. Additionally, when the quality of dubbing in a video decreases, the user experience is degraded.

Indeed, many current video playback systems struggle to estimate dubbing quality in real time. Often, ground truth data is not available while generating dubbed audio segments. Furthermore, many current video playback systems have difficulty determining translation accuracy without a reference, appropriate speaking pace, and/or correct voice matching based on speaker characteristics. Additionally, some current systems struggle with client device resource constraints, such as central processing unit (CPU) and memory usage limitations.

Some video playback systems attempt to address the problem of low-quality dubbing by running post-processing analytics. Post-processing can be complex and resource-intensive. While post-processing can lead to eventual improvement, it does not help resolve poor dubbing problems as they occur in real time. Additionally, post-processing does not enhance the user experience, and some users, unaware that the dubbing quality is poor, may require the system to reprocess segments multiple times in hopes that the quality will improve, which also wastes computational resources.

In contrast, as described in this disclosure, the video dubbing system delivers several significant technical benefits in terms of improved efficiency, accuracy, and flexibility compared to current video playback systems. Furthermore, the video dubbing system provides several practical applications that address problems related to improving the playback of videos by generating and applying dubbing quality scores, as well as utilizing dubbing quality estimation models, dubbing quality reasoning models, and proactive responses.

To illustrate, the video dubbing system provides improved accuracy to the client device by using dubbing metrics and a dubbing quality estimation model to generate a dubbing quality score for dubbed audio segments. Indeed, the dubbing quality estimation model determines quality levels for real-time generated dubbed audio segments in connection with the dubbing segments being generated (e.g., in real time). Furthermore, the dubbing quality estimation model indicates when a dubbed audio segment is of poor or low quality (e.g., fails to meet a dubbing quality threshold corresponding to characteristics and attributes of a dubbed audio segment), and, as described below, the video dubbing system can proactively respond to low-quality dubbed segments (e.g., based on providing notices, providing options to mitigate the poor quality, and/or automatically taking steps to mitigate the poor dubbing quality when possible).

In various implementations, the video dubbing system improves flexibility by providing low-quality dubbing indications to the video player playing the dubbed audio segments. To elaborate, when a generated dubbed audio segment is determined to be of low quality, the video dubbing system generates and provides a low-quality dubbing indication to the video player before and/or while the dubbed audio segment is being played to the user alongside the corresponding video. Additionally, in some instances, the video dubbing system also uses a dubbing quality reasoning model to determine the root cause of the low-quality dubbed segment and can provide a corresponding low-quality dubbing reason along with the low-quality dubbing indication. Proactively providing low-quality dubbing indications and/or low-quality dubbing reasons provides flexibility not found in existing systems.

In many implementations, the video dubbing system improves the efficiency of a client device by detecting low-quality dubbed segments. For example, the video dubbing system can identify or detect low-quality dubbed audio segments in real time and initiate proactive actions and/or measures to improve the dubbing quality. Depending on the reason for the low-quality dubbing, the video dubbing system implements changes to the client device to address the issue and improve quality. In some instances, the video dubbing system utilizes the dubbing metrics associated with the low-quality dubbed audio segments to refine the real-time dubbing process in future iterations.

In addition, the video dubbing system can improve the efficiency of a client device by providing indications of low-quality dubbing audio segments and/or reasons for the low-quality dubbing, offering flexibility not provided by existing systems. For instance, when a user receives a warning (e.g., a low-quality dubbing indication) that the current or next dubbed audio segment is of low quality (and, in some cases, the reason why), the user may allow the low-quality dubbed audio segment to play. Without the low-quality dubbing warning and/or reason, users often rewind the video multiple times in an attempt to enhance the dubbing quality. However, this action causes the client device to waste computing resources by reprocessing the same video segments (e.g., both video and dubbed audio) multiple times. Thus, by providing a low-quality dubbing indication to the video player, the video dubbing system can significantly reduce computational waste and improve the processing efficiency of the client device, as described above.

As illustrated in the foregoing discussion, this disclosure utilizes a variety of terms to describe the features and advantages of one or more implementations described. As an example, the term “video” refers to digital content that includes one or more images in a sequence coupled with audio in a first language. Often, a video includes a sequence of images accompanied by music or audio that includes words spoken or sung in at least a first language. In various implementations, a video includes an image track and an audio track. The audio track may include one or more buffered audio segments or portions.

As another example, the term “audio segment” refers to a specific portion of an audio recording, defined by its start and end points. In some instances, an audio segment corresponds to a video segment. In this document, unless otherwise stated, the term “audio segment” refers to source audio in a first language, and the term “dubbed audio segment” refers to an audio segment in a second language corresponding to the requested dubbed language.

As an example, the terms “dubbing” and “dubbed” refer to applying some or all of an audio translation track to the images of a video. In various implementations, dubbing includes layering or mixing a second audio translation track over a first audio track in a different language. In some instances, dubbing includes adding new dialogue (e.g., translated audio) to the audio track of a video that has already been filmed.

As an example, the term “machine learning” refers to algorithms that generate data-driven predictions or decisions from known input data by modeling high-level abstractions. Examples of machine-learning models include computer representations that are tunable (e.g., trainable) based on inputs to approximate unknown functions. For instance, a machine-learning model includes a model that utilizes algorithms to learn from, and make predictions on, known data by analyzing the known data to learn to generate outputs that reflect patterns and attributes of the known data. For example, machine-learning models include latent Dirichlet allocation (LDA), multi-arm bandit models, linear regression models, logistical regression models, random forest models, support vector machines (SVMs), neural networks (convolutional neural networks, recurrent neural networks such as LSTMs, graph neural networks, etc.), or decision tree models. For example, the speech dubbing model, the dubbing quality estimation model, and the dubbing quality reasoning model are lightweight machine learning models and/or algorithms.

As another example, the term “neural network” refers to a machine learning model comprising interconnected artificial neurons that communicate and learn to approximate complex functions, generating outputs based on multiple inputs provided to the model. For instance, a neural network includes an algorithm (or set of algorithms) that employs deep learning techniques and utilizes training data to adjust the parameters of the network and model high-level abstractions in data. Various types of neural networks exist, such as convolutional neural networks (CNNs), residual learning neural networks, recurrent neural networks (RNNs), generative neural networks, generative adversarial networks (GANs), and single-shot detection (SSD) networks.

As an example, the term “dubbing quality score” refers to a metric that indicates the overall quality of a dubbed audio segment. For example, a dubbing quality estimation model processes various dubbing metrics and/or dubbing metric values to determine a dubbing quality score. By comparing a dubbing quality score to one or more dubbing quality thresholds, a segment can be determined or classified as low quality, average quality, high quality, or another quality level.

As another example, the term “dubbing metrics” refers to measurable characteristics of a dubbed audio segment. Various monitors can identify one or more dubbing metric values corresponding to a dubbing metric. Additionally, dubbing metric values can be determined by processing one or more dubbing metrics. For instance, dubbing metrics can include dubbing metric values that are observed, identified, generated, calculated, or otherwise obtained, as further described below.

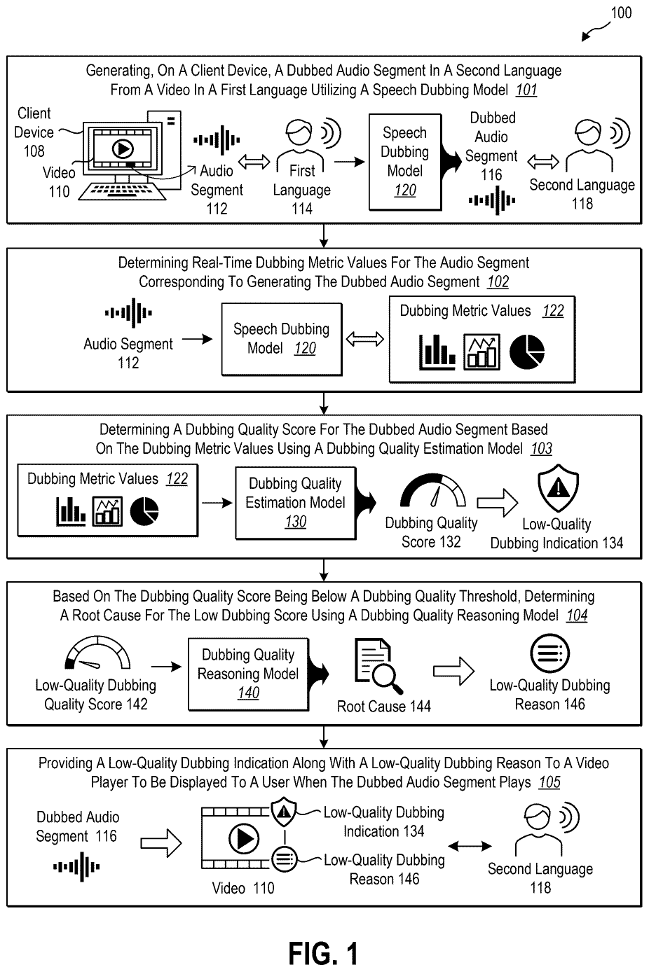

Implementation examples and details of the video dubbing system are discussed in connection with the accompanying figures, which are described next. For example, FIG. 1 illustrates an overview of the video dubbing system that utilizes various machine learning models and dubbing metrics to determine the dubbing quality of segments and to proactively respond to low-quality dubbing segments according to some implementations. In particular, FIG. 1 includes a series of acts 100 for providing video with dubbed translated audio in real time, performed by the video dubbing system.

As shown, the series of acts 100 includes act 101 of generating, on a client device, a dubbed audio segment in a second language from a video in a first language utilizing a sensitivity detection machine-learning model. For example, the video dubbing system receives a request to dub a video 110 into a second language 118 on a client device 108. For instance, an application on the client device 108, such as a media player or a web browser, plays a video 110 to a user in response to detecting a selection to play the video. The application on the client device 108 then detects an audio translation request to play audio for the video 110 in a language different from the language included in the video (e.g., the first language 114). Accordingly, the video dubbing system captures an audio segment 112 in the first language 114 and utilizes a speech dubbing model 120 to generate a dubbed audio segment 116 in the second language 118.

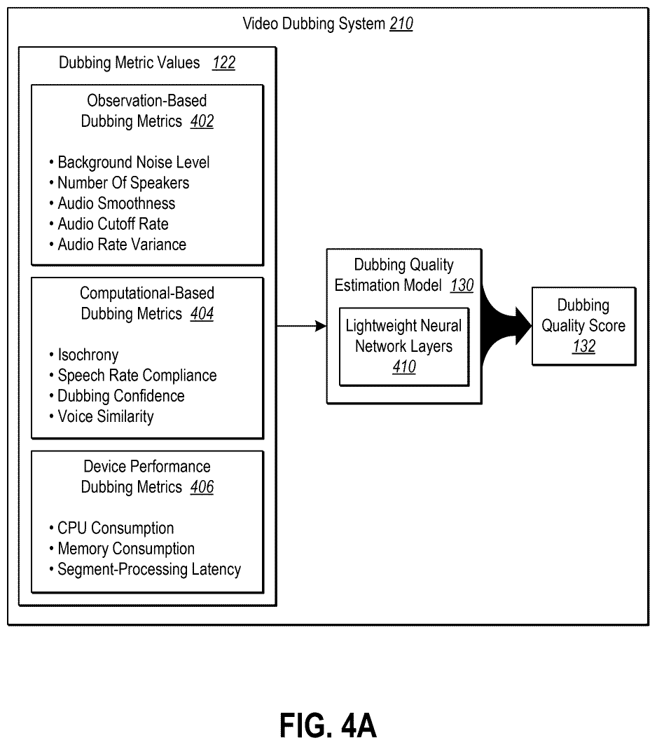

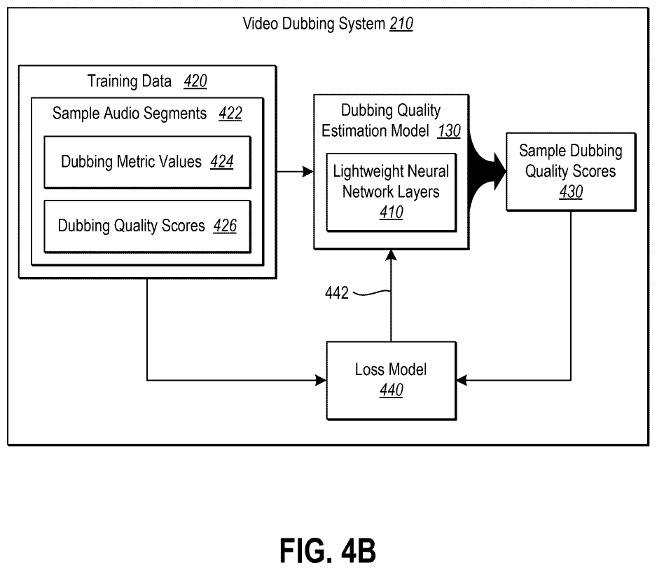

Act 102 includes determining real-time dubbing metric values for the audio segment corresponding to generating the dubbed audio segment. For example, when generating the dubbed audio segment 116 from the audio segment 112 using the speech dubbing model 120, the video dubbing system also identifies, determines, or otherwise captures dubbing metric values 122 that reflect characteristics and attributes of the dubbed audio segment 116 and/or the dubbing process. Additional details about dubbing metric values are provided in connection with FIG. 4A.

Act 103 includes determining a dubbing quality score for the dubbed audio segment based on the dubbing metric values using a dubbing quality estimation model. In various implementations, the video dubbing system generates a dubbing quality estimation model 130 to determine dubbing quality scores from sets of dubbing metric values. Then, using the dubbing quality estimation model 130, the video dubbing system provides the dubbing metric values 122, corresponding to converting the audio segment 112 to the model to generate a dubbing quality score 132. In some instances, if the dubbing quality score 132 is below a dubbing quality threshold, then the video dubbing system determines to create a low-quality dubbing indication 134. Additional details about generating dubbing quality scores for dubbed audio segments are provided in connection with FIGS. 4A-4B.

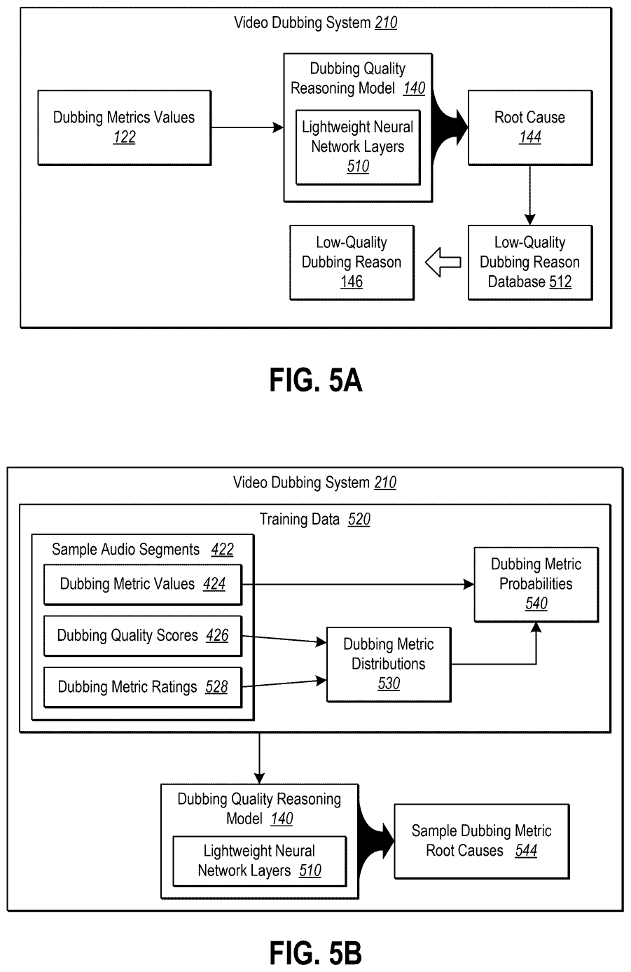

Act 104 includes determining a root cause for the low-quality dubbing score using a dubbing quality reasoning model based on the dubbing quality score being below a dubbing quality threshold. In one or more implementations, in addition to creating a low-quality dubbing indication 134, the video dubbing system provides reasoning for why the dubbed audio segment 116 was of low quality. In various implementations, the video dubbing system provides the low-quality dubbing quality score 142 to a dubbing quality reasoning model 140, which determines a root cause 144. From the first language 114, the video dubbing system can identify or determine a low-quality dubbing reason. Additional details about generating root causes and low-quality dubbing reasons are provided in connection with FIGS. 5A-5B.

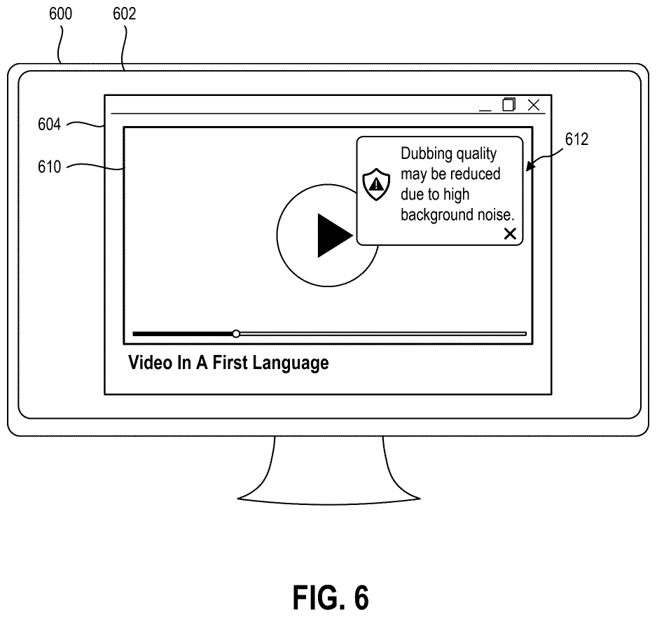

Act 105 includes providing a low-quality dubbing indication along with a low-quality dubbing reason to a video player to be displayed to a user when the dubbed audio segment plays. In various implementations, in anticipation of the dubbed audio segment 116 playing in the second language 118 in the video 110 and the dubbed audio segment 116 being of low quality, the video dubbing system provides the low-quality dubbing indication 134 and/or the low-quality dubbing reason 146 to a video player. In response, the video player can provide or present the low-quality dubbing indication 134 and/or the low-quality dubbing reason 146 before the dubbed audio segment 116 plays, when the dubbed audio segment 116 starts playing, and/or while the dubbed audio segment 116 is currently being played. An example of a low-quality dubbing reason 146 is provided in FIG. 6, which is described below.

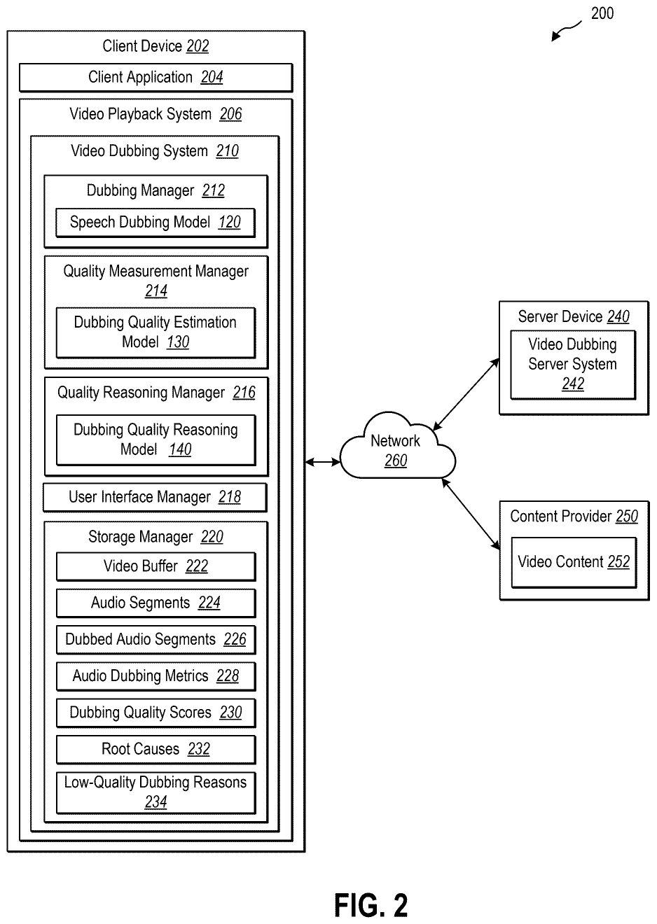

With a general overview in place, additional details are provided regarding the components, features, and elements of the video dubbing system. To illustrate, FIG. 2 shows an example computing environment in which the video dubbing system is implemented according to some implementations. In particular, FIG. 2 illustrates an example of a computing environment 200 with various computing devices, including a client device 202 with a video dubbing system 210, a server device 240 with a video dubbing server system 242, and a content provider 250 with video content 252. The computing devices in the computing environment 200 are connected via a network 260.

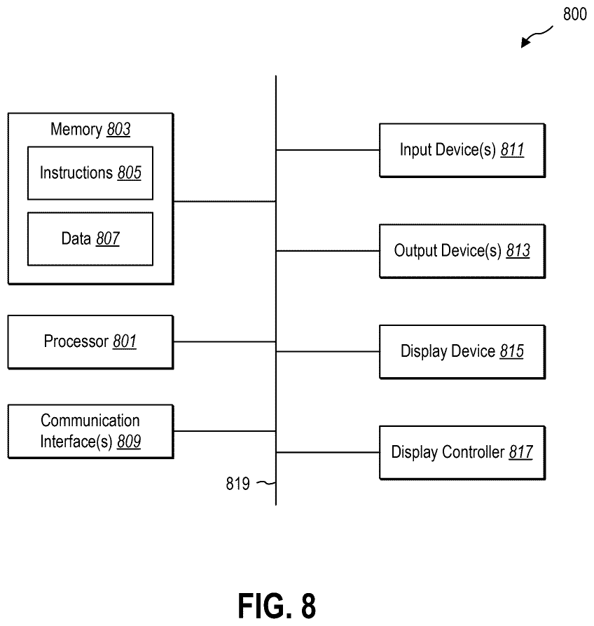

While FIG. 2 shows example arrangements and configurations of the video dubbing system 210 within the computing environment 200, other arrangements and configurations are possible. Additionally, further details regarding computing devices are provided below in connection with FIG. 8, which also includes additional details regarding networks, such as the network 260 shown.

As shown, the computing environment 200 includes a client device 202. As described further below, the client device 202 may correspond to a personal computer (PC) or another personal device, including portable devices that include multithreaded processing capabilities. In various implementations, the client device 202 is associated with a user, such as a user who watches videos. In some implementations, the user requests that a video be played with audio dubbed in another language. For example, the user requests to play a video in a language not included in the original video.

The client device 202 includes a client application 204. In some implementations, the client application 204 represents a software application located on the client device 202, such as a web browser with a video player, a media player, or a content consumption application. In various implementations, the client application 204 obtains and provides (e.g., plays) videos to a user.

The client device 202 also includes a video playback system 206. In various implementations, the video playback system 206 is integrated within the client application 204. For example, the video playback system 206 serves as a feature, plug-in, or extension of the client application 204.

As shown, the video playback system 206 implements the video dubbing system 210. In some implementations, the video dubbing system 210 is located separately from the video playback system 206. In some implementations, the client application 204 communicates with the video playback system 206 and/or the video dubbing system 210 to request and receive real-time audio dubbing for videos played by the client application 204.

In various implementations, including the illustrated implementation, the video dubbing system 210 includes various components and elements implemented in hardware and/or software. For example, the video dubbing system 210 includes a dubbing manager 212, a quality measurement manager 214, a quality reasoning manager 216, a user interface manager 218, and a storage manager 220. The storage manager 220 includes a video buffer 222, audio segments 224, audio dubbing metrics 228, dubbing quality score 230, root causes 232, and low-quality dubbing reasons 234, among other data utilized by the video dubbing system 210.

As shown, the dubbing manager 212 includes a speech dubbing model 120. In various implementations, the dubbing manager 212 utilizes the speech dubbing model 120 to generate dubbed audio segments 226 from audio segments 224 of a video. For example, the dubbing manager 212 stores audio segments 224 from a video in a video buffer 222. The dubbing manager 212 determines 5-20 second segments of audio from the video, referred to as audio segments 224. In some implementations, the video dubbing system 210 uses the speech dubbing model 120 to generate the audio segments 224. For instance, the speech dubbing model 120 features audio segmentation functionality.

Further, in various implementations, the dubbing manager 212 generates translated text segments from the audio segments 224. For example, the speech dubbing model 120 may include speech-to-text functionality, where the speech input is in a first language and the text is translated into a second language. In some implementations, the speech dubbing model 120 also generates the dubbed audio segments 226 by converting the translated text into dubbed audio. For example, the speech dubbing model 120 includes text-to-speech functionality to generate the audio segments 224. In some implementations, the speech dubbing model 120 is a collection of speech dubbing models, including an audio segmentation model, a speech-to-text model, and a text-to-speech model.

As mentioned above, the video dubbing system 210 includes the quality measurement manager 214, which includes the dubbing quality estimation model 130. In various implementations, the quality measurement manager 214 obtains audio dubbing metrics 228 identified, measured, monitored, calculated, determined, or otherwise obtained in connection with converting audio segments 224 to dubbed audio segments 226. In various implementations, the quality measurement manager 214 uses the audio dubbing metrics 228 to generate the quality score 230 for the dubbed audio segments 226. In one or more implementations, the quality measurement manager 214 determines when dubbing quality scores fall below a defined low-quality dubbing threshold, indicating low-quality dubbed audio segments.

As shown, the video dubbing system 210 includes the quality reasoning manager 216, which includes the dubbing quality reasoning model 140. In various implementations, when low-quality dubbed audio segments are determined, the quality reasoning manager 216 uses the dubbing quality reasoning model 140 to determine the root causes 232. Based on the root causes 232, the quality reasoning manager 216 also determines low-quality dubbing reasons 234.

In one or more implementations, the video dubbing system 210 utilizes the user interface manager 218 to provide text, graphics, and/or audio indications to a user regarding the low-quality dubbed audio segments and/or the low-quality dubbing reasons 234. While the above block architecture provides an example implementation of the video dubbing system 210, additional implementations may be included, such as any of the implementations described in connection with the remaining figures.

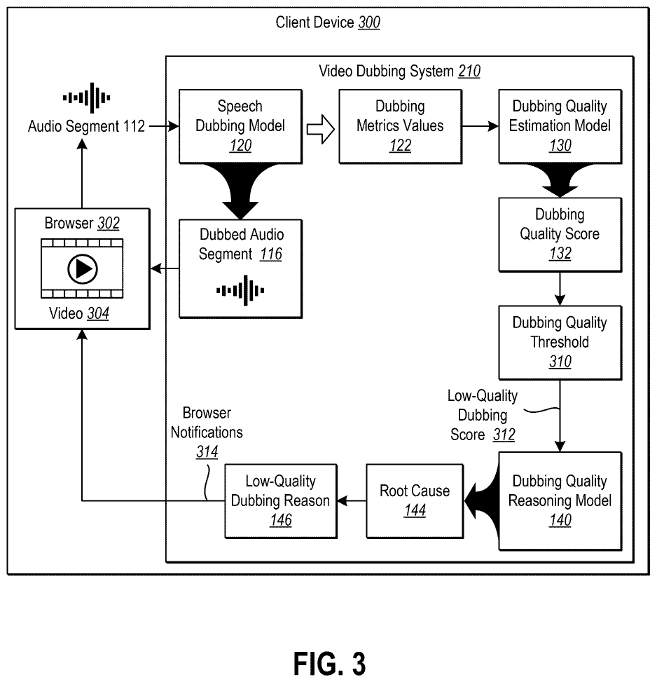

Turning to the next figure, FIG. 3 illustrates the general process and models that the video dubbing system uses to determine dubbing quality scores, reasoning, and reactive actions in response to low-quality audio segments. In particular, FIG. 3 illustrates a high-level block diagram of the video dubbing system determining dubbing quality scores for dubbed audio segments and proactively notifying users according to some implementations.

As shown, FIG. 3 includes a client device 300 with a browser 302 (e.g., a client application) and the video dubbing system 210. The video dubbing system 210 includes models and elements corresponding to generating dubbed audio segments and accurately determining correlated dubbing quality scores.

As also shown, the browser 302 includes a video 304. For example, the video 304 is provided as a stream from a content provider to play within the browser 302. In various implementations, the browser 302 includes one or more selectable options for requesting that the video 304 be translated into another language (e.g., video dubbing). In some implementations, the video dubbing system 210 is integrated within the browser 302, as mentioned above. For example, the video dubbing system 210 may function as a feature or plugin of the browser 302.

In one or more instances, the client device 300 receives or detects a request to play the audio of the video 304 in a different language (e.g., a request to provide real-time dubbing of the video 304). Because the video 304 does not include an audio track in the requested language, the video dubbing system 210 generates and provides the requested language in real time as dubbed audio.

In response to the real-time video dubbing request, the video dubbing system 210 begins receiving audio segments of the video 304. As shown, the video dubbing system 210 receives an audio segment 112. For each audio segment, the video dubbing system 210 may perform a set of operations to convert the audio segment into a dubbed audio segment 116. Accordingly, the example shown in FIG. 3 for the audio segment 112 may be repeated for other audio segments of the video 304.

To illustrate, the audio segment 112 is provided to the speech dubbing model 120, which generates the dubbed audio segment 116, as described above. Along with generating the dubbed audio segment 116, the video dubbing system 210 obtains dubbing metric values 122, which provide indications regarding different aspects of generating or creating the dubbed audio segment 116.

The video dubbing system 210 provides the feature vectors 000 to the dubbing quality estimation model 130 to generate a dubbing quality score 132 for the dubbed audio segment 116. As further described below in connection with FIGS. 4A-4B, the dubbing quality estimation model 130 utilizes one or more of the dubbing metric values 122 in relation to each other to determine or predict the overall quality of the dubbed audio segment 116.

In various implementations, the video dubbing system 210 is directed to identify when the dubbed audio segment 116 is of low quality. Accordingly, as shown, the video dubbing system 210 provides the dubbing quality score 132 to a dubbing quality threshold 310, which determines whether the dubbing quality score 132 is a low-quality dubbing score 312. For example, the video dubbing system 210 compares the dubbing quality score 132 to one or more dubbing quality thresholds, including a low-quality dubbing threshold. If the dubbing quality score 132 fails to meet or exceed the low-quality dubbing threshold, then the dubbed audio segment 116 is deemed to be a low-quality dubbing.

When the dubbed audio segment 116 is classified as a low-quality dubbing, the video dubbing system 210 can determine the root cause and/or the reason behind the low-quality assessment. Accordingly, the video dubbing system 210 utilizes a dubbing quality reasoning model 140 based on the low-quality dubbing score 312 and/or dubbing metric values 122 to determine a root cause 144, which is further described below in connection with FIGS. 5A-5B.

In various implementations, the video dubbing system 210 determines a low-quality dubbing reason 146 based on the root cause 144. For instance, the root cause 144 maps to one or more low-quality dubbing reasons, which provide an explanation for the low-quality dubbing.

Furthermore, as shown, the video dubbing system 210 provides browser notifications 314 to the browser 302 in connection with the dubbed audio segment 116. For example, the browser notifications 314 include a low-quality indication for the dubbed audio segment 116 and/or the low-quality dubbing reason 146. Additionally, the video dubbing system 210 may cause the browser notifications 314 to be displayed before or during the playback of the dubbed audio segment 116 within the video 304.

As mentioned above, FIGS. 4A-4B provide additional details regarding the generation of dubbing quality scores for dubbed audio segments. For instance, FIGS. 4A-4B illustrate the implementation and training of a dubbing quality estimation model to generate dubbing quality scores. In particular, FIG. 4A corresponds to the implementation of a dubbing quality estimation model to generate dubbing quality scores, and FIG. 4B corresponds to the training of a dubbing quality estimation model.

FIG. 4A corresponds to determining or generating a dubbing quality score for a dubbed audio segment. Indeed, FIG. 4A shows the video dubbing system 210 providing the dubbing metric values 122 to the dubbing quality estimation model 130 to generate a dubbing quality score 132 for a dubbed audio segment. In particular, the example diagram in FIG. 4A begins with the generation of the dubbing metric values 122 shown in FIG. 3.

While ground truth data representing accurate translations and dubbed segments may not be available, the video dubbing system 210 can use other observable factors, such as the dubbing metric values 122, to understand the overall quality of the dubbing. As shown, the dubbing metric values 122 include various types of dubbing metrics, including observation-based dubbing metrics 402, computational-based dubbing metrics 404, and device performance dubbing metrics 406.

In various implementations, observation-based dubbing metrics 402 include dubbing metrics that the video dubbing system 210 observed while generating the dubbed audio segment (e.g., leveraging existing metrics generated by or for the speech dubbing model). In some implementations, the observation-based dubbing metrics 402 include dubbing metrics that are primarily generated to aid in the dubbing creation process but are also used as dubbing metric values 122. In some cases, audio models are used to generate an observation-based dubbing metric.

The observation-based dubbing metrics 402 in FIG. 4A show examples of observed dubbing metrics corresponding to the dubbed audio segment. For example, the observation-based dubbing metrics 402 can include background noise levels, the number of speakers, the level of audio smoothness, the audio cutoff rate, and audio rate variance. In some instances, background noise levels correspond to a measure of background noise in the audio segment being converted into the dubbed audio segment. The number of speakers refer to a speaker level score that indicates the number of speakers detected in the audio segment and/or a confidence value that indicates whether each speaker was detected and/or whether audio is being correctly attributed to a speaker.

In various cases, audio smoothness corresponds to the naturalness of the audio and/or whether the audio segment is sped up or slowed down, as changes in playback speed can affect the recognition of natural speech flows. The audio cutoff rate may correspond to the rate or percentage of frames that are cut off, which occurs when playback speeds are too fast (e.g., playback at over 2× speed). The audio rate variance may correspond to a measure of variance in the audio segment. In some implementations, the audio rate variance is an absolute audio rate. In various implementations, the observation-based dubbing metrics 402 include code-mixed speech metrics, which can include instances when multiple languages are mixed together in the original audio segment. The observation-based dubbing metrics 402 can include additional and/or different observation-based dubbing metrics.

As mentioned, the dubbing metric values 122 include computational-based dubbing metrics 404. In various implementations, the video dubbing system 210 generates and/or determines the computational-based dubbing metrics 404 based on processing one or more dubbing metric values 122 or by processing characteristics or attributes created when generating the dubbed audio segment. In various implementations, the video dubbing system 210 utilizes one or more models or algorithms to determine a computational-based dubbing metric.

As shown, the computational-based dubbing metrics 404 in FIG. 4A include example computational-based dubbing metrics corresponding to the dubbed audio segment. For example, the computational-based dubbing metrics 404 include isochrony, speech rate compliance, dubbing confidence, and voice similarity. In some instances, isochrony refers to a lip sync measurement between the audio segment and the dubbed audio segment. Also, along with the number of speakers, a metric indicating frequent changes in speakers can affect dubbing quality. While not shown, the computational-based dubbing metrics 404 can include a metric for pauses that indicate when unnatural breaks occur, which can affect alignment.

In various implementations, speech rate compliance can correspond to a percentage of speech rates that are within a compliant range of speed. Dubbing confidence can correspond to a confidence level or value that the speech dubbing model 120 provides regarding the accuracy of the dubbed audio segment. Similarly, the computational-based dubbing metrics 404 can include a translation confidence score, which corresponds to a confidence score associated with translating the audio segment from a first language to text in a second language. In various instances, voice similarity refers to how closely the audio in the dubbed audio segment matches the voice of the corresponding speaker in the audio segment.

In various implementations, the computational-based dubbing metrics 404 include one or more dubbing metrics for unsupported scenarios, such as those in which the original audio segment includes music content. The computational-based dubbing metrics 404 can include additional and/or different computational-based dubbing metrics.

As mentioned, the dubbing metric values 122 include device performance dubbing metrics 406. In various implementations, the video dubbing system 210 obtains various computing performance metrics from the local client device generating each dubbed audio segment. As described above, generating dubbed audio segments in real time (e.g., near-real time) can be affected and sometimes constrained based on the capabilities of the client device.

As shown, the device performance dubbing metrics 406 in FIG. 4A include some example device performance dubbing metrics corresponding to the dubbed audio segment. For example, the device performance dubbing metrics 406 include CPU consumption, memory consumption, and segment-processing latency. For instance, CPU consumption refers to the CPU power utilized during the processing of a segment. Memory consumption refers to the an amount of memory (e.g., storage memory and/or volatile memory, such as RAM)) used during the processing of a segment. Segment-processing latency includes the latency time and delays that occur due to creating the dubbed audio segment. For instance, latency may arise from audio segment generation, speech translation, background extraction, text-to-speech, speech-to-text, and other processes involved in creating the dubbed audio segment. The device performance dubbing metrics 406 may include additional and/or different device performance dubbing metrics.

As shown, the video dubbing system 210 supplies or provides one or more of the dubbing metric values 122 to the dubbing quality estimation model 130. For example, the video dubbing system 210 provides one or more of the observation-based dubbing metrics 402, computational-based dubbing metrics 404, and/or device performance dubbing metrics 406 to the dubbing quality estimation model 130, which processes the dubbing metrics to determine the dubbing quality score 132 for the dubbed audio segment. In various implementations, the video dubbing system 210 provides all available dubbing metric values. In some instances, the video dubbing system 210 provides only the dubbing metric values 122 on which the dubbing quality estimation model 130 is trained.

As mentioned, the dubbing quality score 132 can represent multiple aspects of the overall dubbing quality of a dubbed audio segment. For example, the dubbing quality score 132 may indicate translation quality, the alignment between the source segment (e.g., the audio segment) and the generated audio segment (e.g., the dubbed audio segment), the speaking rate of the generated audio segment, whether a matching and/or unique voice was assigned for each speaker in the video, speaker voice similarity, whether emotions were transferred correctly, how well sudden transitions in the input were handled, and/or CPU and memory consumption on the client device.

The dubbing quality estimation model 130 includes lightweight neural network layers 410. Indeed, in some implementations, the dubbing quality estimation model 130 is a lightweight machine learning model that quickly and efficiently determines dubbing quality scores. In some instances, the dubbing quality estimation model 130 is an autoencoder model or a type of classifier model, which encodes the dubbing metric values 122 as feature vectors in an embedding space and then decodes the feature vectors into a dubbing quality score.

In various implementations, dubbing quality scores range from 0 to 1, where a higher score corresponds to a higher-quality dubbed audio segment (or vice versa). In some implementations, the video dubbing system 210 uses a different scale. In some cases, the dubbing quality score may be non-numeric.

As mentioned above, FIG. 4B correlates to training the dubbing quality estimation model 130. Training the dubbing quality estimation model 130 can be difficult or challenging, as no direct ground truth data exists that provides correct translations and/or correct dubbed audio segments for corresponding audio segments, to which the dubbing quality estimation model output can be compared.

For example, the video dubbing system 210 generates or obtains training data 420 used to train and/or fine-tune the dubbing quality estimation model 130. As shown, the training data 420 can include sample audio segments 422, which include dubbing metric values 424 and dubbing quality scores 426.

To elaborate, the training data 420 can generate dubbed audio segments from the sample audio segments 422 to obtain the metric values 424. In addition, the video dubbing system 210 can obtain dubbing quality scores 426 for the dubbed audio segments based on the overall quality of the dubbed audio segments. In some instances, the dubbing quality scores 426 are manually provided, such as by users who rate how well the dubbed audio segments sound. In these cases, the dubbing quality scores 426 serve as ground truth data.

The video dubbing system 210 then provides the metric values 424 to the dubbing quality estimation model 130, which generates sample dubbing quality scores 430. Next, the video dubbing system 210 uses a loss model 440 to determine how accurately the dubbing quality estimation model 130 generates the sample dubbing quality scores 430 at each training iteration. For example, the video dubbing system 210 utilizes the loss model 440 to compare the dubbing quality scores 426 (e.g., a ground truth dubbing quality score) of the sample audio segments 422 to the sample dubbing quality scores 430 generated by the dubbing quality estimation model 130 from the same sample audio segments. Indeed, while ground truth dubbing quality scores for each dubbed audio segment are provided to the loss model 440, the video dubbing system 210 does not provide ground truth values for the dubbing metric, as they are not available in many instances.

The loss model 440 may provide feedback 442 (e.g., a dubbing quality score error amount) to the dubbing quality estimation model 130 to fine-tune the lightweight neural network layers 410. Indeed, in various implementations, the video dubbing system 210 utilizes supervised end-to-end learning and loss function optimization to fine-tune the dubbing quality estimation model 130 to generate accurate dubbing quality scores for dubbed audio segments from dubbing metric values.

Furthermore, the video dubbing system 210 trains the dubbing quality estimation model 130 to consider the interactions between different dubbing metric values. In particular, the dubbing quality estimation model 130 learns patterns and predictions among the different combinations of dubbing metric values. By doing so, the video dubbing system 210 trains the dubbing quality estimation model 130 to accurately determine accurate dubbing quality scores for combinations of dubbing metric values that may seem counterintuitive to users (e.g., the dubbing quality score is high despite Dubbing Metric X having a low value).

As mentioned above, FIGS. 5A-5B correspond to generating root causes and low-quality dubbing reasons. For instance, FIGS. 5A-5B illustrate the implementation of and training a dubbing quality reasoning model to determine root causes for low-quality dubbing segments. In particular, FIG. 5A corresponds to the implementation of a dubbing quality reasoning model, and FIG. 5B corresponds to the training of the dubbing quality reasoning model.

As with the above figures, FIGS. 5A-5B illustrate the video dubbing system 210 generating a dubbed audio segment from an audio segment. Specifically, the video dubbing system 210 utilizes the dubbing quality reasoning model 140 for a dubbed audio segment that has a low-quality dubbing score. For example, the dubbing quality score 132 of a dubbed audio segment was below the value of a low-quality dubbing threshold, as described above.

In FIG. 5A, the video dubbing system 210 provides the dubbing metric values 122 to the dubbing quality reasoning model 140 to generate a root cause 144. In some instances, the video dubbing system 210 provides the dubbing quality score (e.g., the low-quality dubbing score) to the dubbing quality reasoning model 140 as an additional input.

In various implementations, the dubbing quality reasoning model 140 is a lightweight model that includes lightweight neural network layers 510. In this manner, the dubbing quality reasoning model 140 quickly and efficiently determines the root cause of a low-quality dubbing score.

As shown, the video dubbing system 210 provides the root cause 144 to a low-quality dubbing reason database 512 to identify or determine a low-quality dubbing reason 146. For example, the video dubbing system 210 identifies a mapping between a root cause 144 and a low-quality dubbing reason 146. In various implementations, multiple root causes may map to a single low-quality dubbing reason (or vice versa). In some implementations, the video dubbing system 210 also uses other factors, such as dubbing metric values, to determine the low-quality dubbing reason 146 for a low-quality dubbed audio segment. Examples of low-quality dubbing reasons are provided below in connection with FIG. 6.

As mentioned above, FIG. 5B correlates to training the dubbing quality reasoning model 140. Again, training the dubbing quality reasoning model 140 can be difficult and challenging due to the lack of ground truth root causes for a low-quality dubbing audio segment to which the output of the dubbing quality reasoning model can be compared.

In various implementations, to train the dubbing quality reasoning model 140, the video dubbing system 210 first generates training data 520. As shown, the training data 520 includes sample audio segments 422 with metric values 424 and dubbing quality scores 426, as introduced above. In addition, the sample audio segments 422 include dubbing metric ratings.

In one or more implementations, the video dubbing system 210 uses the metric values to determine a dubbing metric probability or likelihood for each dubbing metric (e.g., the dubbing metric probabilities 540), indicating the probability that a particular metric is the root cause of the low-quality dubbing audio segment. As a simple example, for a background noise dubbing metric, when the noise level is high, the probability that background noise is responsible (e.g., the root cause) for a low-quality dubbing score is also high. Conversely, when the background noise dubbing metric is low, there is likely a low probability that background noise is the cause of a low-quality dubbing score.

Additionally, the video dubbing system 210 generates dubbing metric distributions 530 based on the dubbing quality scores 426 and dubbing metric ratings 528. In various implementations, the dubbing metric ratings 528 include ground truth ratings of dubbing metric values from the dubbing metrics (e.g., for a given dubbed audio segment, the background noise was rated high at 8/10, the alignment was good, the voice quality was poor, etc.). Accordingly, using the dubbing quality scores 426 and the dubbing metric ratings 528, the video dubbing system 210 can generate dubbing metric distributions 530 (e.g., a distribution for each dubbing metric).

In various implementations, the metric distributions represent a dubbing metric confidence score or class given a dubbing metric value. For example, a dubbing metric for the 0th dubbing quality score class and the 1st dubbing quality score class are plotted, resulting in two distributions. Using the distributions, the video dubbing system 210 can find that the probability of the dubbing metric being in the 0th dubbing quality score class and the probability of the dubbing metric being in the 1st dubbing quality score class. In this example, given a poor dubbing quality score of 0, the video dubbing system 210 may find the probability of the dubbing metric—given the 0th class—will be very high compared to other dubbing metrics (e.g., the dubbing metric is responsible for the low-quality dubbing score).

As shown, to train the dubbing quality reasoning model 140, the video dubbing system 210 provides the training data 520 to the model. In particular, the video dubbing system 210 provides the metric values 424, the dubbing metric probabilities 540, and/or the dubbing metric distributions 530 to the dubbing quality reasoning model 140. The dubbing quality reasoning model 140 then learns to determine which of the metric values 424 is most likely to cause the low-quality dubbing score (e.g., the sample dubbing metric root causes 544).

Indeed, the dubbing quality reasoning model 140 learns how to process the metric values 424, the dubbing metric probabilities 540, and/or the dubbing metric distributions 530 of each metric value, which are often correlated across different dubbing metrics, and outputs one or more of the sample dubbing metric root causes 544. Stated differently, because the dubbing metrics are commonly correlated, the dubbing quality reasoning model 140 determines the metrics relative to each other and figures out how the interplay between dubbing metrics mixes or interacts and which dubbing metric is most responsible for the root cause.

As mentioned above, FIG. 6 provides an example of low-quality indications and example reasons for a low-quality dubbed audio segment. In particular, FIG. 6 illustrates an example graphical user interface for displaying a low-quality dubbing indication within a video player according to some implementations.

As shown, FIG. 6 includes a client device 600 that includes a digital display 602 showing a graphical user interface. The digital display 602 shows an operating system executing an application 604, such as a web browser or media player. The application 604 provides video player functionality to play a video 610 (e.g., a video in a first language).

Additionally, as described above, the client device 600 may detect user input requesting the application 604 provide the audio of the video in a second language (e.g., dubbed audio). In response, the video dubbing system 210 receives the request and provides the dubbed audio in real time (with a slight initial buffer delay (e.g., near-real time)). In particular, the video dubbing system 210 generates dubbed audio segments for sequential audio segments of the video 610 and provides the appropriate dubbed audio segment to the video player for playback.

As mentioned above, the video dubbing system 210 can detect when a dubbed audio segment is of low quality. In particular, the video dubbing system 210 can detect or identify when an upcoming dubbed audio segment is of low quality and may thus result in a negative playback experience. Accordingly, the video dubbing system 210 can take proactive measures to correct the low-quality dubbed audio segment and/or notify the user of the upcoming low-quality dubbed audio segment.

To illustrate, the video dubbing system 210 provides the application 604 with the low-quality dubbing indication 134 and/or low-quality dubbing reason 146 for the upcoming dubbed audio segment. The video dubbing system 210 can cause or instruct the application 604 to provide the low-quality dubbing indication 134 and/or low-quality dubbing reason 146 before the low-quality dubbed audio segment plays, when the low-quality dubbed audio segment starts to play, or while the low-quality dubbed audio segment is playing. As shown, the digital display 602 provides a low-quality indication 612 that includes a low-quality dubbing reason 146 (e.g., “Dubbing quality may be reduced due to high background noise.”).

In various implementations, the low-quality indication 612 appears as a popup interface. In some implementations, the low-quality indication 612 includes a noise notification or another type of alert. In various implementations, the low-quality indication 612 includes a selectable option to close the indication. In some implementations, the low-quality indication 612 automatically disappears after the low-quality dubbed audio segment ends or disappears or a specified or predetermined time period elapses.

Other examples of low-quality dubbing reasons that may appear in the low-quality indication 612 include: dubbing quality may be impacted because music is playing, dubbing quality may be reduced because code-mixing is detected in the video, dubbing quality may be reduced because too many speakers are talking, or dubbing quality may be reduced due to high CPU and memory utilization. Indeed, the video dubbing system 210 can provide various low-quality dubbing reasons, including a high background noise reason, a limited processing resources reason, a code-mixing reason, or a musical content reason.

As noted above, providing a low-quality dubbing reason will often mitigate reactions by users that cause computational waste on the client device. This is even more critical as client devices have limited computational resources. Indeed, when a user is informed of why a dubbed audio segment is of low quality, they are significantly less likely to attempt to have the computing device reprocess the same segment to achieve the same low-quality dubbed audio segment result.

In some implementations, if the low-quality dubbed audio segment results from computational strain on the client device (e.g., due to high CPU and memory utilization), the low-quality indication 612 may include an option to pause the video and recompute the dubbed audio segment with higher quality when computational resources are available, then resume the video.

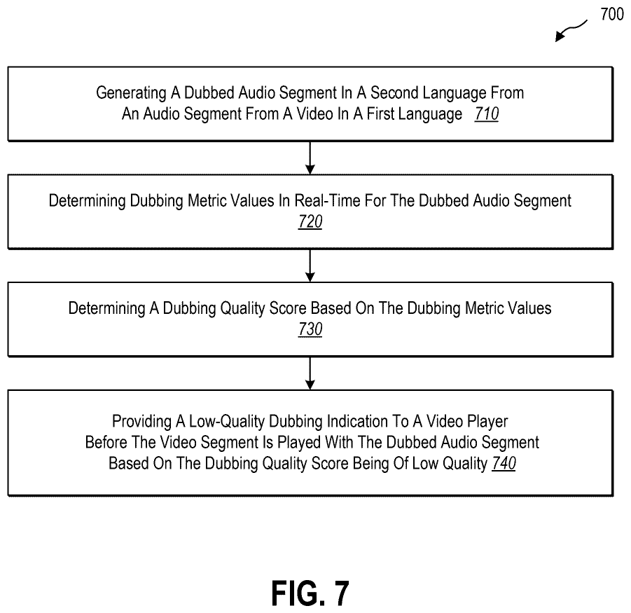

Turning now to FIG. 7, which illustrates an example series of acts in a computer-implemented method for generating real-time audio dubbing metrics in one or more videos on a client device according to some implementations. While FIG. 7 illustrates acts according to one or more implementations, alternative implementations may omit, add, reorder, and/or modify any of the acts shown.

The acts in FIG. 7 can be performed as part of a method (e.g., a computer-implemented method). Alternatively, a computer-readable medium can include instructions that, when executed by a processing system with a processor, cause a computing device to perform the acts in FIG. 7. In some implementations, a system (e.g., a processing system comprising a processor) can perform the acts in FIG. 7. For example, the system includes a processing system and a computer memory including instructions that, when executed by the processing system, cause the system to perform various actions, operations, or steps.

To illustrate, in FIG. 7, the series of acts 700 includes act 710 of generating a dubbed audio segment in a second language from an audio segment from a video in a first language. For instance, in example implementations, act 710 involves generating, on the client device and from an audio segment in a first language corresponding to a video, a dubbed audio segment in a second language. In some implementations, act 710 includes generating, on a client device, a dubbed audio segment in a second language from an audio segment of a video in a first language utilizing a speech dubbing model.

In some implementations, act 710 includes utilizing a speech dubbing model to generate the dubbed audio segment in a second language. In some instances, the speech dubbing model and the video player are implemented by a web browser on the client device. In some instances, the speech dubbing model generates dubbed audio segments in the second language from audio segments of the video in the first language in near-real time for playback by the video player.

As further shown, the series of acts 700 includes act 720 of determining dubbing metric values in real time for the dubbed audio segment. For instance, in example implementations, act 720 involves determining dubbing metric values in real time for a set of dubbing metrics corresponding to generating the dubbed audio segment from the audio segment. In some instances, act 720 includes using a dubbing quality estimation model to determine the dubbing metric values. In various implementations, act 720 includes obtaining a first set of dubbing metric values, including background noise level, number of speakers, audio smoothness, audio cutoff rate, and audio rate variance. In some implementations, act 720 includes obtaining a second set of dubbing metric values, including isochrony, speech rate compliance, dubbing confidence, and voice similarity. In one or more implementations, act 720 includes determining a third set of dubbing metric values, including computer processing unit (CPU) consumption, memory consumption, and segment-processing latency.

As further shown, the series of acts 700 includes act 730 of determining a dubbing quality score based on the dubbing metric values. For instance, in some implementations, act 730 involves determining a dubbing quality score for the dubbed audio segment based on the dubbing metric values. In some implementations, act 730 includes using a dubbing quality estimation model to determine the dubbing quality score for the dubbed audio segment. In various implementations, determining the dubbing quality score for the dubbed audio segment occurs concurrently with the speech dubbing model generating the dubbed audio segment in the second language. In some cases, determining the dubbing quality score for the dubbed audio segment includes using a dubbing quality estimation model that generates the dubbing quality score based on the dubbing metric values.

In some implementations, act 730 includes determining a root cause of the dubbing quality score being below the dubbing quality threshold based on a dubbing quality reasoning model; mapping or determining the root cause to a low-quality dubbing reason from a set of low-quality dubbing reasons; and providing the low-quality dubbing reason to the video player in connection with providing the low-quality dubbing indication. In some instances, act 730 includes determining the root cause for the dubbing quality score being a low-quality dubbing using a dubbing quality reasoning model, determining a low-quality dubbing reason from a set of low-quality dubbing reasons based on the root cause, and providing the low-quality dubbing reason to the video player in connection with providing the low-quality dubbing indication.

In one or more implementations, determining the root cause based on the dubbing quality reasoning model includes providing the dubbing metric values to the dubbing quality reasoning model; providing one or more probability distributions for the dubbing metric values to the dubbing quality reasoning model; providing the dubbing quality score to the dubbing quality reasoning model; and generating the root cause of the low-quality dubbing quality score using the dubbing quality reasoning model.

In various implementations, the dubbing quality estimation model is trained by providing a set of dubbing metric values for dubbing metrics for a sample audio segment to the dubbing quality estimation model; providing a ground truth dubbing quality score for the sample audio segment to a loss model to generate error loss; and training the dubbing quality estimation model based on the error loss to determine dubbing quality scores from sets of dubbing metric values for audio segment samples. In some instances, dubbing metric ground truth values are not provided to the loss model. In some implementations, the set of low-quality dubbing reasons includes a high background noise reason, a limited processing resources reason, a code-mixing reason, or a musical content reason.

Furthermore, the series of acts 700 includes act 740 of providing a low-quality dubbing indication to a video player before the video segment is played with the dubbed audio segment based on the dubbing quality score being of low quality. For instance, in example implementations, act 740 involves providing a low-quality dubbing indication to a video player indicating that a video segment associated with the audio segment is of poor dubbing quality before the video segment is played by the video player with the dubbed audio segment based on determining that the dubbing quality score is below a dubbing quality threshold.

In some implementations, act 740 includes determining a root cause for the dubbing quality score being below the dubbing quality threshold based on a dubbing quality reasoning model and providing a low-quality dubbing indication to a video player indicating that a video segment associated with the audio segment is of poor dubbing quality and a low-quality dubbing reason based on the root cause, wherein the low-quality dubbing indication and the low-quality dubbing reason are provided to the video player to be displayed before or during the dubbed audio segment being played with the dubbed audio segment.

In some instances, act 740 includes determining that the dubbing quality score for the dubbed audio segment is below the dubbing quality threshold. In one or more implementations, a dubbing quality reasoning model determines a root cause for a low dubbing quality score being poor CPU consumption, a low CPU consumption message is determined from a set of low-quality dubbing reasons based on the root cause, and/or providing the low-quality dubbing indication to the video player includes providing the low CPU consumption message for display before the dubbed audio segment is played.

In some instances, the low-quality dubbing indication is displayed on the client device before the video segment is played by the video player with the dubbed audio segment. In various implementations, the video player plays the video with dubbed audio segments in the second language. In some instances, the video player plays the video with dubbed audio segments in the second language. In some implementations, act 740 includes causing the client device to implement changes to improve the quality of the dubbed audio segment (e.g., allocating more computer resources, pausing to the extent allowed by the buffer, implementing various quality improvement models to combat nosy or other reasons causing the poor quality).

FIG. 8 illustrates certain components that may be included within a computer system 800. The computer system 800 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 800 represents one or more of the client devices, server devices, or other computing devices described above. For example, the computer system 800 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 800 includes a processing system including a processor 801. The processor 801 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 801 may be referred to as a central processing unit (CPU) and may cause computer-implemented instructions to be performed. Although the processor 801 shown is just a single processor in the computer system 800 of FIG. 8, in an alternative configuration, a combination of processors (e.g., an ARM and DSP) could be used.

The computer system 800 also includes memory 803 in electronic communication with the processor 801. The memory 803 may be any electronic component capable of storing electronic information. For example, the memory 803 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 805 and the data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in memory 803 and executed by the processor 801. Any of the various examples of data described herein may be among the data 807 that is stored in memory 803 and used during the execution of the instructions 805 by the processor 801.

A computer system 800 may also include one or more communication interface(s) 809 for communicating with other electronic devices. The one or more communication interface(s) 809 may be based on wired communication technology, wireless communication technology, or both. Some examples of the one or more communication interface(s) 809 include a Universal Serial Bus (USB), an Ethernet adapter, a wireless adapter that operates according to an Institute of Electrical and Electronics Engineers (IEEE) 802.11 wireless communication protocol, a Bluetooth® wireless communication adapter, and an infrared (IR) communication port.

A computer system 800 may also include one or more input device(s) 811 and one or more output device(s) 813. Some examples of the one or more input device(s) 811 include a keyboard, mouse, microphone, remote control device, button, joystick, trackball, touchpad, and light pen. Some examples of the one or more output device(s) 813 include a speaker and a printer. A specific type of output device that is typically included in a computer system 800 is a display device 815. The display device 815 used with implementations disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For clarity, the various buses are illustrated in FIG. 8 as a bus system 819.

Furthermore, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that fall within the meaning and range of equivalency of the claims are to be embraced within their scope.

What is claimed is:

1. A computer-implemented method for generating real-time audio dubbing metrics in one or more videos on a client device, comprising:
generating, on the client device and from an audio segment in a first language corresponding to a video, a dubbed audio segment in a second language utilizing a speech dubbing model;
determining dubbing metric values in real time for a set of dubbing metrics corresponding to generating the dubbed audio segment from the audio segment;
determining a dubbing quality score for the dubbed audio segment based on the dubbing metric values; and
based on determining that the dubbing quality score is below a dubbing quality threshold, providing a low-quality dubbing indication to a video player indicating that a video segment associated with the audio segment is of poor dubbing quality before the video segment is played by the video player with the dubbed audio segment.

2. The computer-implemented method of claim 1, wherein determining the dubbing quality score for the dubbed audio segment includes using a dubbing quality estimation model that generates the dubbing quality score based on the dubbing metric values.

3. The computer-implemented method of claim 1, further comprising:
determining a root cause for the dubbing quality score being a low-quality dubbing using a dubbing quality reasoning model;
determining a low-quality dubbing reason from a set of low-quality dubbing reasons based on the root cause; and
providing the low-quality dubbing reason to the video player in connection with providing the low-quality dubbing indication.

4. The computer-implemented method of claim 3, wherein determining the root cause based on the dubbing quality reasoning model includes:
providing the dubbing metric values to the dubbing quality reasoning model;
providing one or more probability distributions for the dubbing metric values to the dubbing quality reasoning model;
providing the dubbing quality score to the dubbing quality reasoning model; and
generating the root cause of the dubbing quality score using the dubbing quality reasoning model.

5. The computer-implemented method of claim 4, wherein the set of low-quality dubbing reasons includes a high background noise reason, a limited processing resources reason, a code-mixing reason, or a musical content reason.

6. The computer-implemented method of claim 1, further comprising obtaining a first set of dubbing metric values, including background noise level, number of speakers, audio smoothness, audio cutoff rate, and audio rate variance.

7. The computer-implemented method of claim 1, further comprising obtaining a second set of dubbing metric values, including isochrony, speech rate compliance, dubbing confidence, and voice similarity.

8. The computer-implemented method of claim 1, further comprising determining a third set of dubbing metric values, including computer processing unit (CPU) consumption, memory consumption, and segment-processing latency.

9. The computer-implemented method of claim 1, wherein:
a dubbing quality reasoning model determines a root cause for a low dubbing quality score being poor CPU consumption;
a low CPU consumption message is determined from a set of low-quality dubbing reasons based on the root cause; and
providing the low-quality dubbing indication to the video player includes providing the low CPU consumption message for display before the video segment is played.

10. The computer-implemented method of claim 1, wherein determining the dubbing quality score for the dubbed audio segment occurs concurrently with the speech dubbing model generating the dubbed audio segment in the second language.

11. The computer-implemented method of claim 1, wherein the speech dubbing model and the video player are implemented by a web browser on the client device.

12. The computer-implemented method of claim 1, wherein the speech dubbing model generates dubbed audio segments in the second language from audio segments of the video in the first language in near-real time for playback by the video player.

13. The computer-implemented method of claim 1, further comprising causing the client device to implement changes to improve a quality of the dubbed audio segment.

14. A system comprising:
a processing system having a processor; and
a computer memory including instructions that, when executed by the processing system, cause the system to carry out operations comprising:
generating, on a client device, a dubbed audio segment in a second language from an audio segment of a video in a first language utilizing a speech dubbing model;
determining dubbing metric values in real time for a set of dubbing metrics corresponding to generating the dubbed audio segment from the audio segment;
determining a dubbing quality score for the dubbed audio segment based on the dubbing metric values using a dubbing quality estimation model;
determining that the dubbing quality score for the dubbed audio segment is below a dubbing quality threshold; and
based on determining that the dubbing quality score is below the dubbing quality threshold, providing a low-quality dubbing indication to a video player indicating that a video segment associated with the audio segment is of poor dubbing quality, wherein the video player plays the video with dubbed audio segments in the second language.

15. The system of claim 14, wherein the low-quality dubbing indication is displayed on the client device before the video segment is played by the video player with the dubbed audio segment.

16. The system of claim 14, wherein the dubbing quality estimation model is trained by:
providing a set of dubbing metric values for dubbing metrics for a sample audio segment to the dubbing quality estimation model;
providing a ground truth dubbing quality score for the sample audio segment to a loss model to generate error loss, wherein dubbing metric ground truth values are not provided to the loss model; and
training the dubbing quality estimation model based on the error loss to determine dubbing quality scores from sets of dubbing metric values for audio segment samples.

17. A computer-implemented method for generating real-time audio dubbing metrics in one or more videos, comprising:
generating, on a client device and from an audio segment in a first language corresponding to a video, a dubbed audio segment in a second language;
determining dubbing metric values in real time for a set of dubbing metrics corresponding to generating the dubbed audio segment from the audio segment;
determining a dubbing quality score for the dubbed audio segment based on the dubbing metric values using a dubbing quality estimation model; and
based on determining that the dubbing quality score is below a dubbing quality threshold:
determining a root cause for the dubbing quality score being below the dubbing quality threshold based on a dubbing quality reasoning model; and
providing a low-quality dubbing indication to a video player indicating that a video segment associated with the audio segment is of poor dubbing quality and a low-quality dubbing reason based on the root cause, wherein the low-quality dubbing indication and the low-quality dubbing reason are provided to the video player to be displayed before or during the dubbed audio segment being played by the video player with the dubbed audio segment.

18. The computer-implemented method of claim 17, wherein the video player plays the video with dubbed audio segments in the second language.

19. The computer-implemented method of claim 17, further comprising:
determining the root cause for the dubbing quality score being a low-quality dubbing using the dubbing quality reasoning model;
determining the low-quality dubbing reason from a set of low-quality dubbing reasons based on the root cause; and
providing the low-quality dubbing reason to the video player in connection with providing the low-quality dubbing indication.

20. The computer-implemented method of claim 17, further comprising determining that the dubbing quality score for the dubbed audio segment is below the dubbing quality threshold.
